(19) United States
(12) Patent Application Publication
(10) Pub. No.: US 2016/0028423 A1
(43) Pub. Date: Jan. 28, 2016

(54) NOISE POWER ESTIMATION IN DIGITAL COMMUNICATIONS SYSTEMS WITH FAST FADING CHANNELS

(71) Applicant: SIRIUS XM RADIO INC., New York, NY (US)

(72) Inventors: Sharif Sazzad, Ewing, NJ (US); Carl Scarpa, Plainsboro, NJ (US); Edward Schell, Jackson, NJ (US)

(21) Appl. No.: 14/774,930

(22) PCT Filed: Mar. 18, 2014
(86) PCT No.: PCT/US2014/031109

§ 371 Date: Sep. 11, 2015

Related U.S. Application Data
(60) Provisional application No. 61/786,336, filed on Mar. 15, 2013.

(51) Int. Cl. H04B 1/10; H04L 1/20; H04L 25/06

(52) U.S. Cl. CPC H04B 1/10; H04L 25/062; H04L 1/20

(57) ABSTRACT

An accurate and fast method for estimation of noise power in digital communication systems is presented. Exemplary embodiments of the present invention do not rely upon the need for embedding reference sequences in the transmitted data. Accordingly, such exemplary embodiments are especially suited for tracking variations of noise power in digital communication systems with fast fading channels.

### CROSS-REFERENCE TO RELATED APPLICATIONS

This application claims the benefit of U.S. Provisional Patent Application No. 61/786,336, filed on Mar. 15, 2013, entitled NOISE POWER ESTIMATION IN DIGITAL COMMUNICATIONS SYSTEMS WITH FAST FADING CHANNELS, the disclosure of which is hereby incorporated by reference in its entirety. This application is filed on Mar. 18, 2014, inasmuch as Mar. 15, 2013 was a Saturday, and Monday Mar. 17, 2014 the United States Patent and Trademark Office was closed due to inclement weather.

### TECHNICAL FIELD

The present invention relates to digital communications systems, and in particular to noise power estimation in digital communications systems with fast fading channels.

### BACKGROUND OF THE INVENTION

### DA and NDA Noise Power Estimators

In digital communication systems, a receiver employs error correction techniques to combat the effects of impairments in the communication channel (such as, for example, fading and noise). Modern error correction schemes require reliable estimates of noise power for optimum performance. To address this requirement, various exemplary embodiments of the present invention present a fast and accurate method for estimating noise power.

In general, there are two general classes of noise estimators: Data-Aided (DA) and Non Data-Aided (NDA). Data-Aided (DA) estimators rely on some known reference data sequence in the received signal itself to generate noise estimates. DA estimators are described, for example, in D. R. Paulizzi and N. N. Baeulieu, “A Comparison of SNR estimation techniques for the AWGN channel”, IEEE Trans. Commun., vol. 48, no. 10, pp. 1681-1691, October 2000 (“Paulizzi and Baeulieu”); and in C. E. Gilchriest, “Signal-to-noise monitoring”, JPL Space Programs Summary, vol. IV, no. 37-27, pp. 169-184, June 1966.

DA estimators can make fast and reliable estimates that can accurately represent the noise level at the time of occurrence of the reference data sequence. Thus, if the reference data sequence is present at short periodic intervals, a DA estimator can provide frequent updates of the noise level. However, this creates waste. Placing reference sequences at frequent intervals into a communication system robs bandwidth that is available for actual data transmission. On the other hand, in communication systems where the reference sequences appear less frequently, the rate of DA estimates will be correspondingly less. A low noise level estimation rate thus becomes problematic in communication systems where channel characteristics are varying quickly with time. This is due to the fact that noise level estimates can quickly become “stale”, i.e. they may no longer accurately represent the state of nature (i.e., the then extant state of the channel).

Non Data-Aided (NDA) estimators, described, for example, in Paulizzi and Beaulieu (see above), for example, and also described, for example, in R. Matzner, “An SNR Estimation Algorithm For Complex Baseband Signals Using Higher Order Statistics”, Facta Universtitatis (Nis), Series: Electronics and Energetics, vol. 6, no. 1, (1993), pp. 41-52, do not depend upon any known reference data. Instead, using knowledge of the signaling scheme used in a digital communication system, NDA estimators infer the noise level based on statistics extracted from the received signal.

What is needed in the art are faster and more accurate NDA methods for estimation of noise power in digital communication systems.

### SUMMARY OF THE INVENTION

An accurate and fast Non-Data Aided (NDA) method for estimation of noise power in digital communication systems is presented. Thus, exemplary embodiments of the present invention do not rely upon the need for embedding reference sequences in the transmitted data. Accordingly, such exemplary embodiments are especially suited for tracking variations of noise power in digital communication systems with fast fading channels.

### BRIEF DESCRIPTION OF THE DRAWINGS

FIG. 1 depicts an exemplary geometric representation of a signaling scheme;

FIG. 2 depicts an exemplary geometric representation of a corrupted signal;

FIG. 3 depicts a geometric representation of hard-slicing;

FIG. 4 is a plot of simulation results of a raw ddEDE estimator according to an exemplary embodiment of the present invention;

FIG. 5 illustrates partitioning of a signal space according to exemplary embodiments of the present invention;

FIG. 6 depicts scenarios of three exemplary different noise levels;

FIG. 7 depicts an exemplary correction curve according to an exemplary embodiment of the present invention;

FIG. 8 depicts an exemplary complete architecture of a ddEDE estimator correction curve according to an exemplary embodiment of the present invention;

FIG. 9 depicts an exemplary windowed ddEDE estimator according to an exemplary embodiment of the present invention; and

FIG. 10 illustrates data alignment for the case where N=3 according to an exemplary embodiment of the present invention.

### DETAILED DESCRIPTION OF THE INVENTION

Inasmuch as NDA estimators do not rely upon prior knowledge of the received data, noise level estimates may be generated much more frequently than when using DA estimators. Moreover, NDA estimators do not occupy otherwise valuable bandwidth by sending embedded reference data sequences. This is advantageous in communication systems where channel characteristics may vary quickly with time. In what follows, NDA estimators according to various exemplary embodiments of the present invention are described that are low complexity, fast and accurate, and that can be implemented in hardware or software, or any combination of them. An exemplary NDA estimator described herein shall sometimes be referred to as a “decision-directed Euclidean Distance Estimator” (ddEDE).

### Euclidean Distance as a Measure of Noise

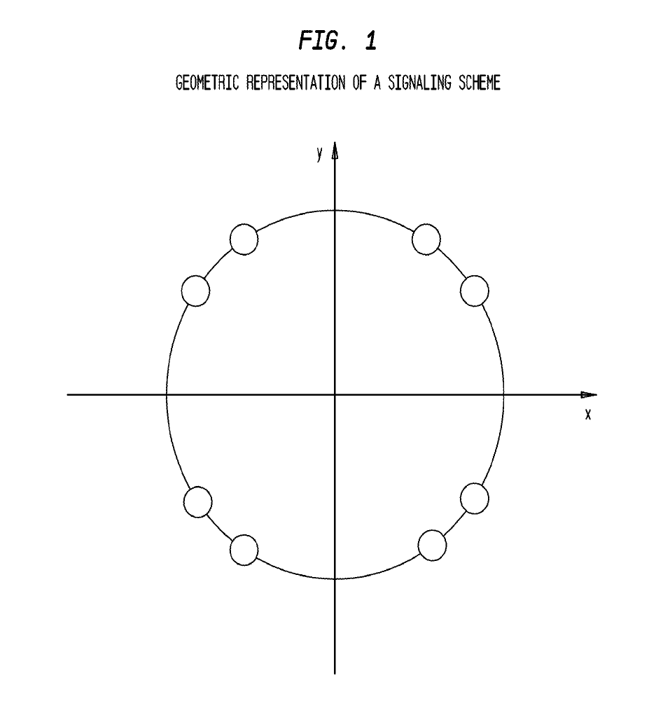

As background to understanding the inventive decision-directed Euclidean Distance Estimator (ddEDE), the basic idea of Euclidean distance and its use as a measure of noise is presented. In communication theory, a signaling scheme used in a system is often represented geometrically. For example, in FIG. 1 a signaling scheme with a set of eight points is represented in the X-Y plane. This set of points has a so-called “constant modulus” property. Geometrically, this means that each point is equidistant from the origin and hence they all fall on a circle about the origin. The exemplary signaling scheme shown in FIG. 1 will be used herein to describe various algorithms according to various embodiments of the present invention. However, of course, the utility of the present invention is understood not to be restricted to the exemplary signaling scheme shown in FIG. 1.

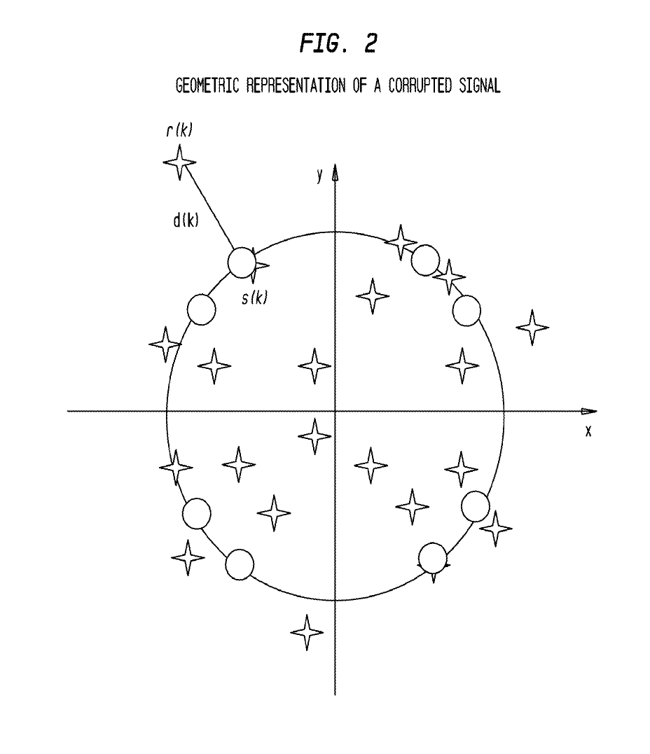

In exemplary embodiments of the present invention, a transmitter may select a sequence of points from this signal set and use this sequence to generate a signal that is sent through a physical communications channel, e.g. a satellite broadcast channel, to a receiver. The receiver attempts to recover the sequence of points that was transmitted. However, the complication is that the communications channel through which the signal was sent corrupts the signal—making the receiver see a signal that is different from what was actually transmitted. An example of the effect of signal corruption is represented geometrically in FIG. 2.

In FIG. 2, the original signal set (the eight (8) circles of FIG. 1) is included as a visual reference. However, what the receiver actually observes (receives) are the points shown as stars. These differ from the original signal set due to the corruptive effects of the communication channel.

In exemplary embodiments of the present invention, a specific type of signal corruption that is of interest is Additive White Gaussian Noise (AWGN). This can be modeled mathematically, for example, using the equation below:

r=s+n

where s is the transmitted signal, n is the additive noise and r is the received signal.

Geometrically, the effect of additive noise can be seen as a shift of a point away from its correct location in the signal set. For example, in FIG. 2, the received points (shown as stars) are seen to be offset in various directions from the original points of the signal set (i.e. the 8 circles). The further away a point is from its original signal set point, the higher the noise level for that point. A measure of the noise level can, for example, be based on the Euclidean distance from a received point to its corresponding originally transmitted signal set point. Thus, in FIG. 2, the received point r(k) has a distance d(k) from its corresponding signal set point s(k). In a time window of L consecutively received points, the average noise level or noise power may thus be computed as follows:

$${n}_{EDE}^{2} = \frac{1}{L} {\sum }_{k = 0}^{L - 1} {d}^{2} ( k ) = \frac{1}{L} {\sum }_{k = 0}^{L - 1} {\vert r ( k ) - s ( k ) \vert}^{2}$$

Where n²_{EDE} is the average noise power based on the Euclidean Distance Estimation (EDE) method, r(k) is the received sequence and s(k) is the sequence that was originally transmitted. Of course, in a normal communication system the values of s(k) are generally unknown to the receiver. To aid in the noise estimation, short reference sequences can be transmitted periodically, however as mentioned earlier, this robs valuable bandwidth otherwise available for actual data.

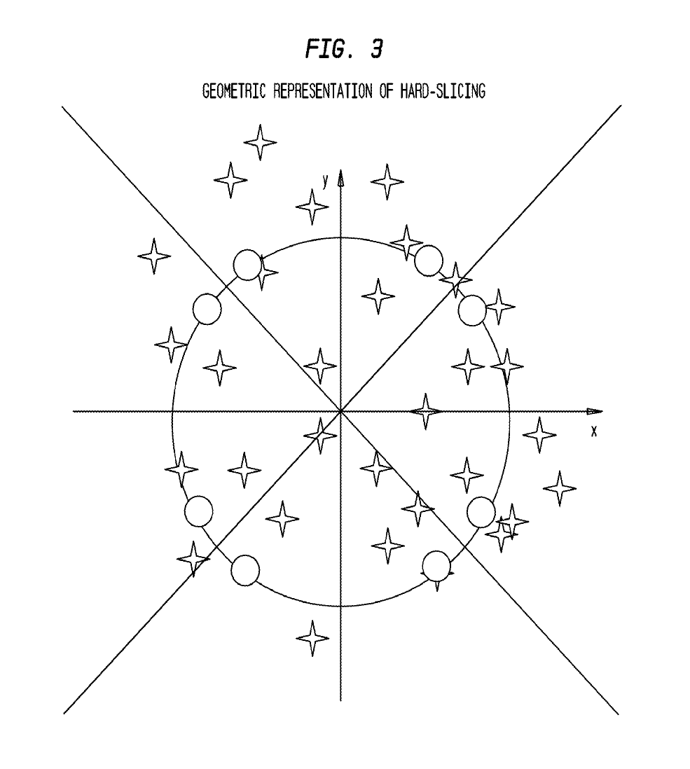

In exemplary embodiments of the present invention, to avoid the need for transmission of known sequences, the inventive method observes the received sequence of points r(k) and produces a new sequence of points ŝ(k), which is an estimate of the transmitted sequence. This is done using a technique called “hard-slicing.” FIG. 3 depicts geometrically the principle of hard-slicing.

As the example of FIG. 3 shows, since there are eight points in the original signal set (i.e. the 8 circles of FIG. 1), the X-Y plane can be, for example, partitioned into eight regions with exactly one point from the signal set in each. If a received point is observed to fall in a particular partition then the hard-slicing algorithm will decide that the received point was originally the set point that is contained in that partition. Thus, the inventive technique maps each received point to a point in the signal set to which it is closest. Hence, for each r(k)

\hat{s}(k)=signal set point closest to r(k)

Using a sequence of k points ŝ(k) produced by the hard-slicing, the following computation can, for example, be made:

$${n}_{ddEDE , raw}^{2} = \frac{1}{K} {\sum }_{k = 0}^{K - 1} {\vert \hat{s} ( k ) - r ( k ) \vert}^{2}$$

Where n²_{ddEDE, raw} is the raw decision-directed Euclidean Distance Estimate (ddEDE), r(k) are received points, and s(k) are hard-sliced points obtained from r(k).

In exemplary embodiments of the present invention, the value of n²_{ddEDE, raw} represents the average noise power in the K-sample interval over which the computation is made. For low levels of noise, this technique, based on the Euclidean distance between the received signal points and their corresponding sliced points, works well. However, as the noise level increases, the technique can produce values of n²_{ddEDE, raw} that underestimate the true noise level.

When the noise level is low, the hard-slicing process used to produce the sequence of points ŝ(k) from the received points is likely to have few slicing errors, i.e. most of hard-sliced points are mapped to the correct signal set points. As the noise level increases, however, the number of received points that are sufficiently offset to cross into the decision region of a neighboring set also increases—resulting in an increasing number of hard-slicing errors. Thus, assigning a received point to the nearest signal set point in this situation can result in an underestimate of the noise power, because the true signal set point is actually further away (i.e., d(k) as shown in FIG. 2 is larger).

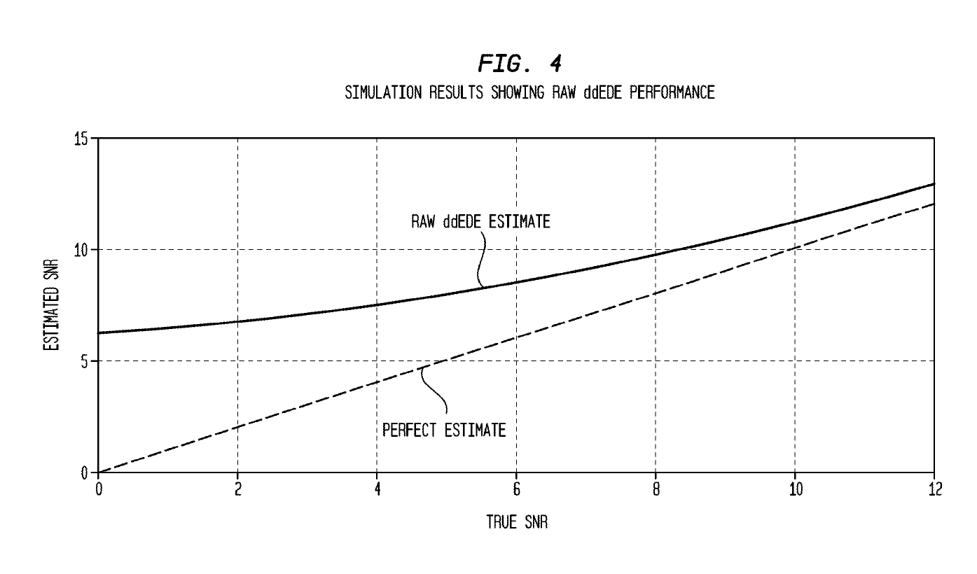

FIG. 4 shows simulation results of the raw ddEDE estimator performance for various levels of noise. Note that the graph shows the performance in terms of signal-to-noise ratio (SNR), which is based on the noise power and is computed as follows (using a signal power of 2):

$${SNR}_{ddEDE , raw} = 10 {log}_{10} ( \frac{2}{{n}_{ddEDE , raw}^{2}} )$$

The expected SNR value for the simulation is presented on the x-axis. The ideal estimator would be a straight line with Y=X (this is shown as the dashed line) in FIG. 4. However, the performance curve for the raw ddEDE estimator (the solid curve) shows that for high SNR, the ddEDE estimate approaches the theoretically correct value. However, as noise level increases, which results in decreasing SNR, the ddEDE estimate diverges from the theoretically correct value, and significantly so for SNR≦4.

In order to compensate for this divergence, in exemplary embodiments of the present invention a correction factor can, for example, be applied to the raw ddEDE estimator to better match the ideal result. This can be represented as follows:

n²_{ddEDE}=n²_{ddEDE, raw}×correction(SNR),

where n²_{ddEDE} is the final (corrected) noise estimate, n²_{ddEDE, raw} is the raw ddEDE noise estimate and correction(SNR) is a correction factor.

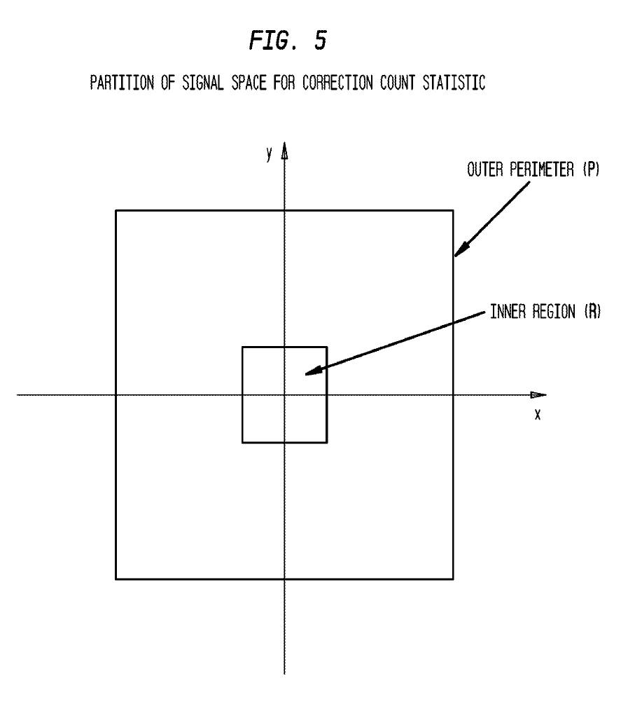

As the correction factor is a function of the SNR, and the SNR is unknown, in exemplary embodiments of present invention a novel technique can be used to compute a statistic of the SNR from which the correction factor may be inferred. This statistic is called the “correction count”. To compute the correction count statistic, the signal space can be, for example, partitioned as shown in FIG. 5 below. The “outer perimeter” (P) is a boundary of the signal space and marks the extreme limits possible for the signal points. The “inner region” (R) is some subset shown here around the center of the signal space. It is noted that although P and R are depicted as square shapes for clarity, they are not restricted to these shapes. Square shapes are generally preferred due to their simplified implementation, however, circular shapes may be used, or, for example, polygonal shapes, or, for example, arbitrary shapes. In exemplary embodiments of the present invention, even asymmetric shapes may be used, if it is known that the noise pattern for the channel is asymmetric in the XY plane about the center. Thus, whatever shape size and distance from the perimeter are most useful may be used.

For a sequence of K received points, the correction count statistic can, for example, be computed as follows:

correction count=(number of points in R)+(number of points on P)

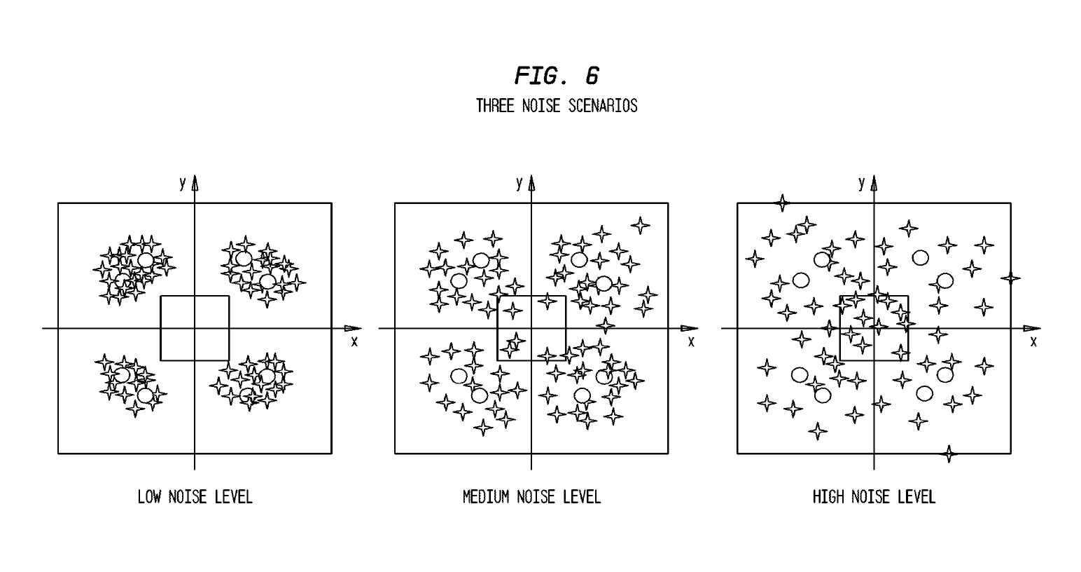

Thus, FIG. 6. shows example scenarios of three different noise levels. In the “Low noise level” scenario shown in the left side of FIG. 6, the received points are only slightly perturbed by the additive noise and they tend to form clusters around their original signal set positions. In this case, there are no points in either R or on P. In the “Medium noise level” scenario shown in the middle of FIG. 6, the received points are more spread out and some points appear in R. In the “High noise level” scenario, there are many more points in R and even some on P. Thus, for low noise levels the correction count statistic has a small value but as the noise level increases so does the correction count.

It is noted that one may create the outer perimeter P to be slightly within the signal space, and thus allow points to either fall on P, or beyond it, if appropriate in given contexts to more accurately measure the noise level.

This correlation between the noise level and the correction count can be used, for example, in exemplary embodiments of the present invention, to apply a correction to n²_{ddEDE, raw} and thereby obtain a better noise estimate, as follows:

n²_{ddEDE}=n²_{ddEDE, raw}×correction(correction_count)

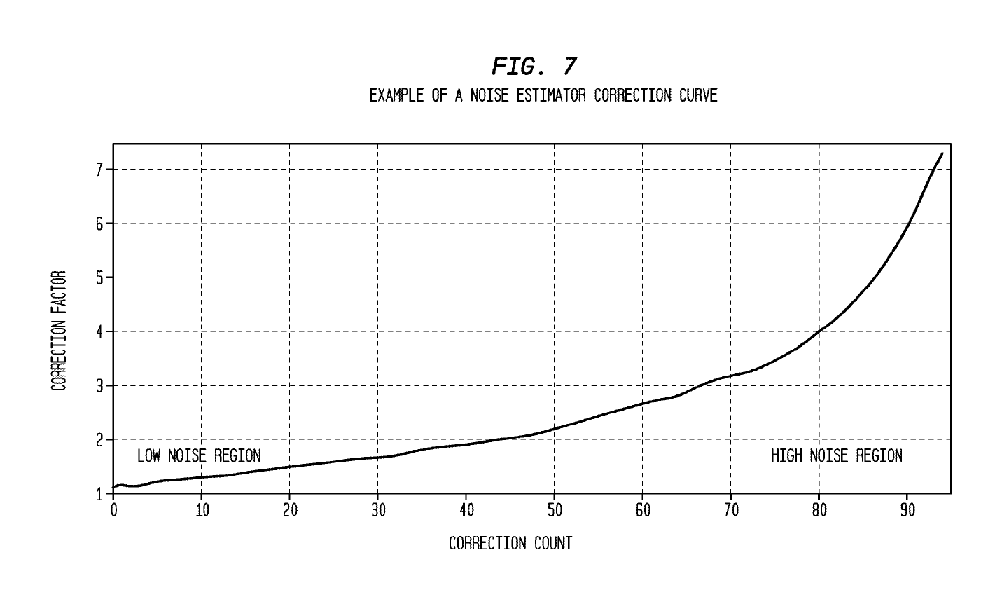

The relationship between the noise level and the correction count can, for example be determined using a simulation, or by measurement of one or more actual communications systems. Once this relationship is determined, it is possible to construct a correction curve similar to the one shown in FIG. 7. This example curve was obtained using an implementation where K=384, a unit box centered about the origin as region R, a perimeter square with a side length of 4 centered about the origin as the perimeter, and using the signaling scheme as shown previously in FIG. 1.

The correction curve in FIG. 7 can be constructed by taking the required correction factor at each SNR and plotting it against the associated average correction count at each corresponding SNR. This gives the correction factor as a function of the correction count.

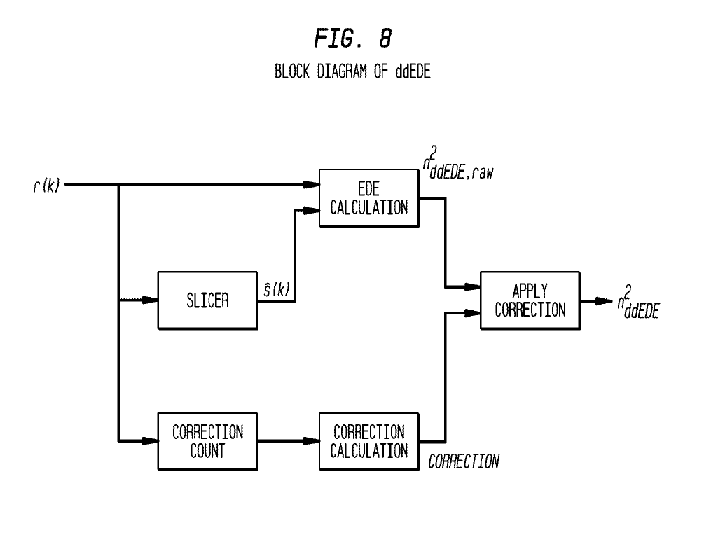

The block diagram in FIG. 8 illustrates an exemplary complete architecture of an example ddEDE estimator, where r(k) is the received signal sequence and n²_{ddEDE} is the ddEDE noise estimate. For every block of K points of r(k), a new value of n²_{ddEDE} can be produced, which represents the average noise power in the channel for that block of points.

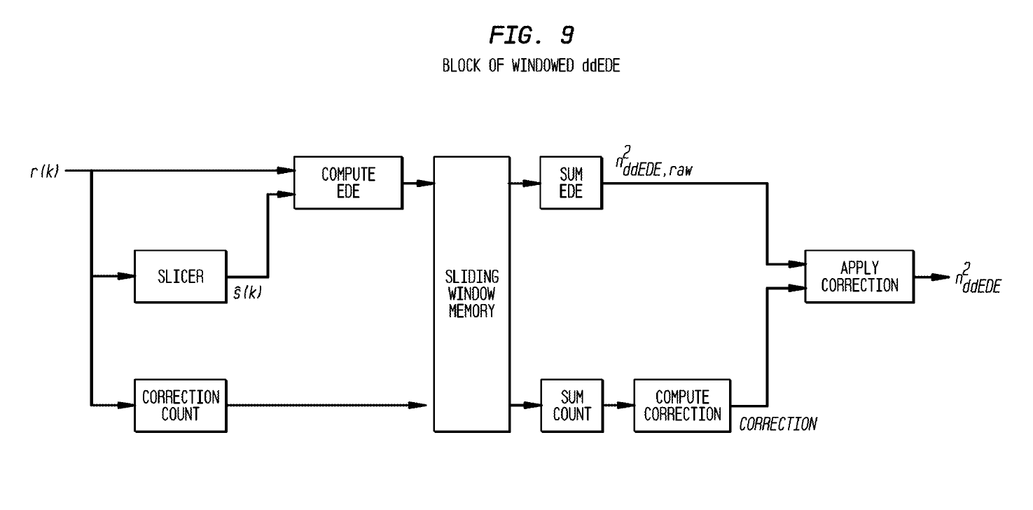

In exemplary embodiments of the present invention, it is possible to modify the basic ddEDE estimator structure shown in FIG. 8 to produce an estimate for every block of K points averaging over a total of L points where L=N×K. This may be done, for example, to reduce the variance of the estimates while maintaining a desired rate of production. The goal in such an implementation is to tune the estimator to be sufficiently sensitive to rapid changes in signal quality that can occur in a fast fading communication channel, while maintaining good accuracy. This modification to the ddEDE may, for example, be called the windowed ddEDE estimator, and is shown in FIG. 9.

In exemplary embodiments of the present invention, the received data r(k) can, for example, be processed in blocks of K points—the statistics n²_{ddEDEK} and correction_count_{K} can, for example, be calculated (where the subscript K is used to indicate that each statistic is computed using blocks of K samples). These statistics can be, for example, stored in a sliding window memory.

Thus, in exemplary embodiments of the present invention the sliding window can maintain the last N computed statistics n²_{ddEDEK} and correction_count_{K}. For example, for N=3, after the computation of T blocks of received data the sliding window memory will, for example, contain:

| | |
|---|---|
| n_{ddEDE}_{K}² (T) | correction_count_{K} (T) |
| n_{ddEDE}_{K}² (T − 1) | correction_count_{K} (T − 1) |
| n_{ddEDE}_{K}² (T − 2) | correction_count_{K} (T − 2) |

Then, after the statistics for the next input block, (T+1), have been computed, the sliding window memory will contain:

| | |
|---|---|
| n_{ddEDE}_{K}² (T + 1) | correction_count_{K} (T + 1) |
| n_{ddEDE}_{K}² (T) | correction_count_{K} (T) |
| n_{ddEDE}_{K}² (T − 1) | correction_count_{K} (T − 1) |

As every block is processed, the following computations can, for example, be performed on the data in the sliding window:

$${n}_{ddEDE , raw}^{2} = {\sum }_{n = 0}^{N - 1} {n}_{{ddEDE}_{K}}^{2} ( n )$$

$$correction\_count = {\sum }_{n = 0}^{N - 1} {correction\_count}_{K} ( n )$$

This effectively aggregates the individual block statistics to form statistics n²_{ddEDE, raw} and correction_count over a sliding window of N blocks or L=N×K input samples. Using the aggregate correction_count statistic, a corrector factor can be determined and then applied to n²_{ddEDE, raw} to compute the final n²_{ddEDE}.

In exemplary embodiments of the present invention, the choices of N and K may be specific to the needs of a particular communication system. In a communication system that performs error control in blocks of K samples—this value of K becomes a natural choice for the update rate of the noise estimates. If the value of K is small, it is then possible to select a suitable value of N to reduce the variance in the estimates while maintaining sufficient sensitivity to be able to track quick variations in the signal quality.

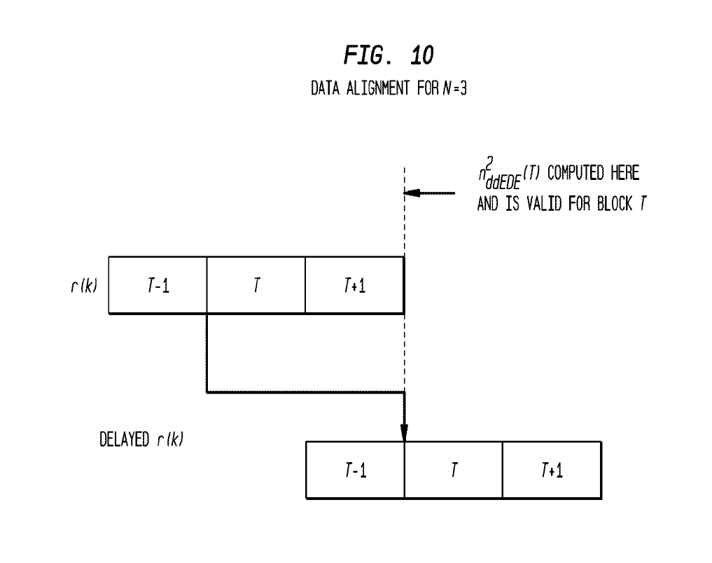

It is important to note that each ddEDE estimate is valid for that block of K points used to compute the estimate. In the windowed ddEDE implementation the estimate is valid for the block of K points around the center of the window. An implementation, whether done in hardware or software, must thus preserve the proper alignment of the noise estimates with their corresponding blocks. This can be done by delaying the received signal sequence r(k) by the processing delay incurred in the computation of a noise estimate. An example of this alignment process (for N=3) is depicted in FIG. 10.

In FIG. 10, the flow of time flows from left to right. For N=3, the windowed ddEDE estimate n²_{ddEDE} (T), is produced at just after T+1 has been observed. Since the estimate is valid for block T of input data the data must be delayed as shown to maintain the proper alignment.

What has been described above utilizes the decision-directed Euclidean Distance (ddEDE) algorithm, and also describes a variant—a windowed ddEDE algorithm, which uses a window of blocks of data to balance estimator variance and estimator sensitivity to signal quality variations. This ability to “tune” the estimator performance to meet specific needs of a communication system is a useful feature of various exemplary embodiments of the present invention.

### Exemplary Systems

In exemplary embodiments of the present invention, any suitable programming language can be used to implement the routines of particular embodiments including C, C++, Java, JavaScript, Python, Ruby, CoffeeScript, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage device or non-transitory computer readable medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/Figs. can also be implemented in a more separated or integrated manner, or even removed or rendered as inoperable in certain cases, as is useful in accordance with a particular application. It is also within the spirit and scope to implement a program or code that can be stored in a machine-readable medium, such as a storage device, to permit a computer to perform any of the methods described above.

As used in the description herein and throughout any claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While there have been described methods for organization and presentation of photos thereof, it is to be understood that many changes may be made therein without departing from the spirit and scope of the invention. Insubstantial changes from the claimed subject matter as viewed by a person with ordinary skill in the art, no known or later devised, are expressly contemplated as being equivalently within the scope of the claims. Therefore, obvious substitutions now or later known to one with ordinary skill in the art are defined to be within the scope of the defined elements. The described embodiments of the invention are presented for the purpose of illustration and not of limitation.

What is claimed:

1. A method for estimating noise power in digital communication systems, comprising:
receiving a sequence of points r(k) at a receiver over a communications channel;
generating a modified sequence of points ŝ(k) by hard slicing; and
generating a first noise power estimate for the communications channel as:
$${n}_{ddEDE , raw}^{2} = \frac{1}{K} {\sum }_{k = 0}^{K - 1} {\vert \hat{s} ( k ) - r ( k ) \vert}^{2} ,$$
where r(k) are received points and ŝ(k) are hard-sliced points obtained from r(k).

2. The method of claim 1, wherein said hard slicing includes determining the closest point of an original signal set point s(k) to each received point r(k) using Euclidean distance.

3. The method of claim 1, further comprising modifying the first noise power estimate by a correction factor to generate a second noise power estimate.

4. The method of claim 3, wherein said correction factor is a function of the signal to noise ratio for the channel, correction(SNR).

5. The method of claim 4, wherein the correction factor is inferred from statistics of the received sequence of points r(k) that indicate a signal to noise ratio for the communications channel.

6. The method of claim 5, further comprising:
dividing the signal space into two regions, and inner region spaced about the center of the signal space, and an outer perimeter of the signal space;
counting the number of received points (i) within the inner region and (ii) lying either on the outer perimeter or beyond it; and
adding the received points satisfying either condition to obtain a correction count.

7. The method of claim 6, wherein the two regions are squares in the XY plane of the signal space, and drawn such that points falling within the inner region, or on or beyond the outer perimeter are most noisy.

8. The method of claim 6, wherein the two regions are circular or polygonal.

9. The method of claim 6, wherein the two regions are asymmetric, drawn based on known or inferred noise patterns for the channel.

10. The method of any of claims 6-9, wherein the correction factor is a function of the correction count, and the second noise power estimate is obtained by multiplying the correction factor with the first noise power estimate, as
n²_{ddEDE}=n²_{ddEDE, raw}×correction(correction_count).

11. The method of claim 10, wherein the relationship between the noise level and the correction count, and thus the correction factor, is determined using a simulation or by measurement of an actual communication system.

12. The method of claim 10, wherein the first noise power estimate and the correction count are calculated for each of a number of N most recent sequential blocks of data and stored in one of a memory and a sliding window memory.

13. The method of claim 12, further comprising:
performing the following calculations on the data in the memory:
$${n}_{ddEDE , raw}^{2} = {\sum }_{n = 0}^{N - 1} {n}_{{ddEDE}_{K}}^{2} ( n )$$
$$correction\_count = {\sum }_{n = 0}^{N - 1} {correction\_count}_{K} ( n )$$
to obtain aggregate statistics over a sliding window of N blocks of data, and using the aggregate correction_count statistic, determining a corrector factor and applying it to n²_{ddEDE, raw} to compute a final n²_{ddEDE}.

14. The method of claim 3, wherein the first noise power estimate and the correction count are calculated for each of a number of N most recent sequential blocks of data and stored in one of a memory and a sliding window memory.

15. The method of claim 3, further comprising:
performing the following calculations on the data in the memory:
$${n}_{ddEDE , raw}^{2} = {\sum }_{n = 0}^{N - 1} {n}_{{ddEDE}_{K}}^{2} ( n )$$
$$correction\_count = {\sum }_{n = 0}^{N - 1} {correction\_count}_{K} ( n )$$
to obtain aggregate statistics over a sliding window of N blocks of data, and using the aggregate correction_count statistic, determining a corrector factor and applying it to n²_{ddEDE, raw} to compute a final n²_{ddEDE}.

16. The method of claim 15, further comprising preserving a proper alignment of noise estimates with their corresponding blocks.

17. The method of claim 16, wherein said preserving a proper alignment includes delaying the received signal sequence r(k) by a processing delay incurred in the computation of the noise estimate so as to apply the appropriate second noise power estimate to a block N once said second noise power estimate has been computed.

18. A non-transitory computer readable medium containing instructions that, when executed by at least one processor of a computing device, cause the computing device to:
receive a sequence of points r(k) at a receiver over a communications channel;
generate a modified sequence of points ŝ(k) by hard slicing; and
generate a first noise power estimate for the communications channel as:
$${n}_{ddEDE , raw}^{2} = \frac{1}{K} {\sum }_{k = 0}^{K - 1} {\vert \hat{s} ( k ) - r ( k ) \vert}^{2} ,$$
where r(k) are received points and ŝ(k) are hard-sliced points obtained from r(k).

19. The non-transitory computer readable medium of claim 18, wherein said hard slicing includes determining the closest point of an original signal set point s(k) to each received point r(k) using Euclidean distance.

20. The non-transitory computer readable medium of claim 18, said instructions further causing the at least one processor to modify the first noise power estimate by a correction factor to generate a second noise power estimate.

21. The non-transitory computer readable medium of claim 20, wherein said correction factor is a function of the signal to noise ratio for the channel, correction(SNR).

22. The non-transitory computer readable medium of claim 21, wherein the correction factor is inferred from statistics of the received sequence of points r(k) that indicate a signal to noise ratio for the communications channel.

23. The non-transitory computer readable medium of claim 22, said instructions further causing the at least one processor to:
divide the signal space into two regions, and inner region spaced about the center of the signal space, and an outer perimeter of the signal space;
count the number of received points (i) within the inner region and (ii) lying either on the outer perimeter or beyond it; and
add the received points satisfying either condition to obtain a correction count.

24. The non-transitory computer readable medium of claim 23, wherein the two regions are squares in the XY plane of the signal space, and drawn such that points falling within the inner region, or on or beyond the outer perimeter are most noisy.

25. The non-transitory computer readable medium of claim 23, wherein the two regions are circular or polygonal.

26. The non-transitory computer readable medium of claim 23, wherein the two regions are asymmetric, drawn based on known or inferred noise patterns for the channel.

27. The non-transitory computer readable medium of claims 23-26, wherein the correction factor is a function of the correction count, and the second noise power estimate is obtained by multiplying the correction factor with the first noise power estimate, as
n²_{ddEDE}=n²_{ddEDE, raw}×correction(correction_count).

28. The non-transitory computer readable medium of claim 27, wherein the relationship between the noise level and the correction count, and thus the correction factor, is determined using a simulation or by measurement of an actual communication system.

29. The non-transitory computer readable medium of claim 27, wherein the first noise power estimate and the correction count are calculated for each of a number of N most recent sequential blocks of data and stored in one of a memory and a sliding window memory.

30. The non-transitory computer readable medium of claim 29, said instructions further causing the at least one processor to:
perform the following calculations on the data in the memory:
$${n}_{ddEDE , raw}^{2} = {\sum }_{n = 0}^{N - 1} {n}_{{ddEDE}_{K}}^{2} ( n )$$
$$correction\_count = {\sum }_{n = 0}^{N - 1} {correction\_count}_{K} ( n )$$
to obtain aggregate statistics over a sliding window of N blocks of data, and using the aggregate correction_count statistic, determine a corrector factor and apply it to n²_{ddEDE, raw} to compute a final n²_{ddEDE}.

31. The non-transitory computer readable medium of claim 20, wherein the first noise power estimate and the correction count are calculated for each of a number of N most recent sequential blocks of data and stored in one of a memory and a sliding window memory.

32. The non-transitory computer readable medium of claim 20, said instructions further causing the at least one processor to:
perform the following calculations on the data in the memory:
$${n}_{ddEDE , raw}^{2} = {\sum }_{n = 0}^{N - 1} {n}_{{ddEDE}_{K}}^{2} ( n )$$
$$correction\_count = {\sum }_{n = 0}^{N - 1} {correction\_count}_{K} ( n )$$
to obtain aggregate statistics over a sliding window of N blocks of data, and using the aggregate correction_count statistic, determine a corrector factor and apply it to n²_{ddEDE, raw} to compute a final n²_{ddEDE}.

33. The non-transitory computer readable medium of claim 32, said instructions further causing the at least one processor to:
preserve a proper alignment of noise estimates with their corresponding blocks.

34. The non-transitory computer readable medium of claim 33, wherein said preserving a proper alignment includes delaying the received signal sequence r(k) by a processing delay incurred in the computation of the noise estimate so as to apply the appropriate second noise power estimate to a block N once said second noise power estimate has been computed.

35. A receiver, comprising at least one data processor and a memory containing instructions that, when executed, cause the at least one processor to:
receive a sequence of points r(k) at a receiver over a communications channel;
generate a modified sequence of points ŝ(k) by hard slicing; and
generate a first noise power estimate for the communications channel as:
$${n}_{ddEDE , raw}^{2} = \frac{1}{K} {\sum }_{k = 0}^{K - 1} {\vert \hat{s} ( k ) - r ( k ) \vert}^{2} ,$$
where r(k) are received points and ŝ(k) are hard-sliced points obtained from r(k).

36. The receiver of claim 35, said instructions further causing the at least one processor to modify the first noise power estimate by a correction factor to generate a second noise power estimate.

37. The receiver of claim 36, wherein said correction factor is a function of the signal to noise ratio for the channel, correction(SNR).

38. The receiver of claim 36, wherein said correction factor is a function of the signal to noise ratio for the channel, correction(SNR).

39. The receiver of claim 36, wherein the correction factor is inferred from statistics of the received sequence of points r(k) that indicate a signal to noise ratio for the communications channel.

40. The receiver of claim 36, said instructions further causing the at least one processor to:
divide the signal space into two regions, and inner region spaced about the center of the signal space, and an outer perimeter of the signal space;
count the number of received points (i) within the inner region and (ii) lying either on the outer perimeter or beyond it; and
add the received points satisfying either condition to obtain a correction count.

41. The receiver of claim 40, wherein the two regions are squares in the XY plane of the signal space, and drawn such that points falling within the inner region, or on or beyond the outer perimeter are most noisy.

42. The receiver of claim 40, wherein the two regions are circular or polygonal.

43. The receiver of claim 40, wherein the two regions are asymmetric, drawn based on known or inferred noise patterns for the channel.

44. The receiver of claims 40-43, wherein the correction factor is a function of the correction count, and the second noise power estimate is obtained by multiplying the correction factor with the first noise power estimate, as
n²_{ddEDE}=n²_{ddEDE, raw}×correction(correction_count).

45. The receiver of claim 44, wherein the relationship between the noise level and the correction count, and thus the correction factor, is determined using a simulation or by measurement of an actual communication system.

46. The receiver of claim 44, wherein the first noise power estimate and the correction count are calculated for each of a number of N most recent sequential blocks of data and stored in one of a memory and a sliding window memory.

47. The receiver of claim 46, said instructions further causing the at least one processor to:
perform the following calculations on the data in the memory:
$${n}_{ddEDE , raw}^{2} = {\sum }_{n = 0}^{N - 1} {n}_{{ddEDE}_{K}}^{2} ( n )$$
$$correction\_count = {\sum }_{n = 0}^{N - 1} {correction\_count}_{K} ( n )$$
to obtain aggregate statistics over a sliding window of N blocks of data, and using the aggregate correction_count statistic, determine a corrector factor and apply it to n²_{ddEDE, raw} to compute a final n²_{ddEDE}.

48. The receiver of claim 37, wherein the first noise power estimate and the correction count are calculated for each of a number of N most recent sequential blocks of data and stored in one of a memory and a sliding window memory.

49. The receiver of claim 47, said instructions further causing the at least one processor to:
perform the following calculations on the data in the memory:
$${n}_{ddEDE , raw}^{2} = {\sum }_{n = 0}^{N - 1} {n}_{{ddEDE}_{K}}^{2} ( n )$$
$$correction\_count = {\sum }_{n = 0}^{N - 1} {correction\_count}_{K} ( n )$$
to obtain aggregate statistics over a sliding window of N blocks of data, and using the aggregate correction_count statistic, determine a corrector factor and apply it to n²_{ddEDE, raw} to compute a final n²_{ddEDE}.

50. The receiver of claim 49, said instructions further causing the at least one processor to:
preserve a proper alignment of noise estimates with their corresponding blocks.

51. The receiver of claim 50, wherein said preserving a proper alignment includes delaying the received signal sequence r(k) by a processing delay incurred in the computation of the noise estimate so as to apply the appropriate second noise power estimate to a block N once said second noise power estimate has been computed.
